(19) United States
(12) Patent Application Publication
(10) Pub. No.: US 2026/0037603 A1
(43) Pub. Date: Feb. 5, 2026

(54) MACHINE LEARNING AND MULTI-STAGE PROMPTING TECHNIQUES FOR GENERATING TARGET CLASSIFICATION SIGNATURES

(71) Applicant: Optum, Inc., Minnetonka, MN (US)

(72) Inventors: Sanjit Singh BATRA, Redwood City, CA (US); Robert Elliott TILLMAN, Long Island City, NY (US)

(21) Appl. No.: 18/791,643

(22) Filed: Aug. 1, 2024

(51) Int. Cl. G06F 18/2413; G06N 3/045; G06N 3/0475; G06N 3/09

(52) U.S. Cl. CPC G06F 18/2413; G06N 3/045; G06N 3/0475; G06N 3/09

(57) ABSTRACT

Various embodiments of the present disclosure provide machine learning architectures and data processing techniques for improving computer-based text comprehension. The techniques include generating, using a trained classifier model, target classification probabilities for labelled text-based objects from a testing portion of a labelled training dataset and identifying predictive text-based objects from the labelled text-based objects based on the target classification probabilities. The techniques include applying a staged prompting mechanism with a generative extraction model to identify a target set of explanatory text segments from the predictive text-based objects that may be clustered into semantic segment clusters. The techniques include generating explanatory summary segments respectively corresponding to the semantic segment clusters and generating a target classification signature based on a plurality of terms from the one or more explanatory summary segments.

### BACKGROUND

Various embodiments of the present disclosure address technical challenges related to various machine learning technologies and may be applied in various domains to improve computer-based classification and detection techniques. Target classifications, such as diseases in a clinical domain, computer viruses in a computer security domain, and/or the like, are associated with data that describe various attributes of the classification. This data may be reflected by textual descriptions, clinical records, activity logs, and/or other textual evidence of the classification. Textual evidence includes various entities, such as words, phrases, and the like, that may vary in their predictive significance with respect to the classification. An open problem in machine learning is extracting the most predictive entities from textual data for a particular classification. Due to the subjective nature of text, traditional methods require multiple manual iterations with a subject matter expert to converge on a relevant list of entities. Such techniques are resource intensive and impractical for large scale use cases. An alternative to the traditional method may use large language models. However, such techniques lack accuracy due to large language model hallucinations. Even without hallucinations, a disproportionate mix of relevant and irrelevant entities within source text prevent large language model solutions from accurately extracting the most predictive entities for a particular classification.

These technical challenges, among others, prevent the generation of digital signatures that may be used to track target classifications within a computer. Various embodiments of the present disclosure make important contributions to traditional machine learning technologies by addressing these technical challenges, among others.

### BRIEF SUMMARY

Various embodiments of the present disclosure provide a machine learning and multi-stage prompting pipeline that improves traditional computer-based text interpretation and extraction with respect to generating digital signatures at scale. To address the technical challenges discussed above, various embodiments of the present disclosure present a model pipeline that is configured to detect relevant entities from text through a multi-stage filtering process. At each stage of the filtering process, traditional deficiencies in machine learning are locally addressed to optimize the performance of a machine learning technique for a particular filtering operation. At a first stage, for example, a machine learning classifier may be built to detect predictive portions of text that include entity rich text data for extracting relevant entities. To do so, the machine learning classifier may be trained to generate target classification probabilities for a target classification. These target classification probabilities may be adapted to a filtering task by extracting portions of text associated with a highest set of target classification probabilities. At a second stage, a staged prompting mechanism may be applied with a large language model to iteratively extract predictive text segments from the pre-filtered portions of text. By using a staged prompting mechanism, the techniques of the present disclosure may prevent hallucinations in text while extracting granular details from the pre-filtered portions of text. At a third stage, the predictive text segments are clustered and summarized by a second language model. These final explanatory summary segments may be used as a basis for a target classification signatures that optimally reflect predictive and detectable features of a target classification. By using a multi-stage filtering process, the model pipeline of the present disclosure allows for drop-in replacements of various models and algorithms at each stage of the process and is therefore able to build upon the progress in language models, rather than hinging on a particular model or algorithm.

In some embodiments, a computer-implemented method comprises generating, by one or more processors and using a trained classifier model, a plurality of target classification probabilities for a plurality of labelled text-based objects from a testing portion of a labelled training dataset; identifying at a first stage, by the one or more processors, one or more predictive text-based objects from the plurality of labelled text-based objects based on the plurality of target classification probabilities; identifying at a second stage, by the one or more processors and via staged prompting to a generative extraction model, a target set of explanatory text segments from the one or more predictive text-based objects; generating, by the one or more processors, one or more semantic segment clusters from the target set of explanatory text segments; generating, by the one or more processors and using a generative summarization model, one or more explanatory summary segments respectively corresponding to the one or more semantic segment clusters; extracting at a third stage, by the one or more processors, a sequence of words from the one or more explanatory summary segments to generate a target classification signature; and storing, by the one or more processors, the target classification signature in association with a target classification.

In some embodiments, a system comprising memory and one or more processors communicatively coupled to the memory, the one or more processors configured to generate, using a trained classifier model, a plurality of target classification probabilities for a plurality of labelled text-based objects from a testing portion of a labelled training dataset; identify at a first stage, one or more predictive text-based objects from the plurality of labelled text-based objects based on the plurality of target classification probabilities; identify at a second stage, via staged prompting to a generative extraction model, a target set of explanatory text segments from the one or more predictive text-based objects; generate one or more semantic segment clusters from the target set of explanatory text segments; generate, using a generative summarization model, one or more explanatory summary segments respectively corresponding to the one or more semantic segment clusters; extract at a third stage, a sequence of words from the one or more explanatory summary segments to generate a target classification signature; and store the target classification signature in association with a target classification.

In some embodiments, one or more non-transitory computer-readable storage media including instructions that, when executed by one or more processors, cause the one or more processors to generate, using a trained classifier model, a plurality of target classification probabilities for a plurality of labelled text-based objects from a testing portion of a labelled training dataset; identify at a first stage, one or more predictive text-based objects from the plurality of labelled text-based objects based on the plurality of target classification probabilities; identify at a second stage, via staged prompting to a generative extraction model, a target set of explanatory text segments from the one or more predictive text-based objects; generate one or more semantic segment clusters from the target set of explanatory text segments; generate, using a generative summarization model, one or more explanatory summary segments respectively corresponding to the one or more semantic segment clusters; extract at a third stage, a sequence of words from the one or more explanatory summary segments to generate a target classification signature; and store the target classification signature in association with a target classification.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for generating a target classification signature of a target classification in accordance with some embodiments of the present disclosure.

FIG. 5 is an operational example of an initial extraction phase from a labelled training dataset in accordance with some embodiments of the present disclosure.

FIG. 6 is an operational example of a staged prompting mechanism in accordance with some embodiments of the present disclosure.

FIG. 7 is a flowchart diagram of an example process for generating a target classification signature of a target classification in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. COMPUTER PROGRAM PRODUCTS, METHODS, AND COMPUTING ENTITIES

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. EXAMPLE FRAMEWORK

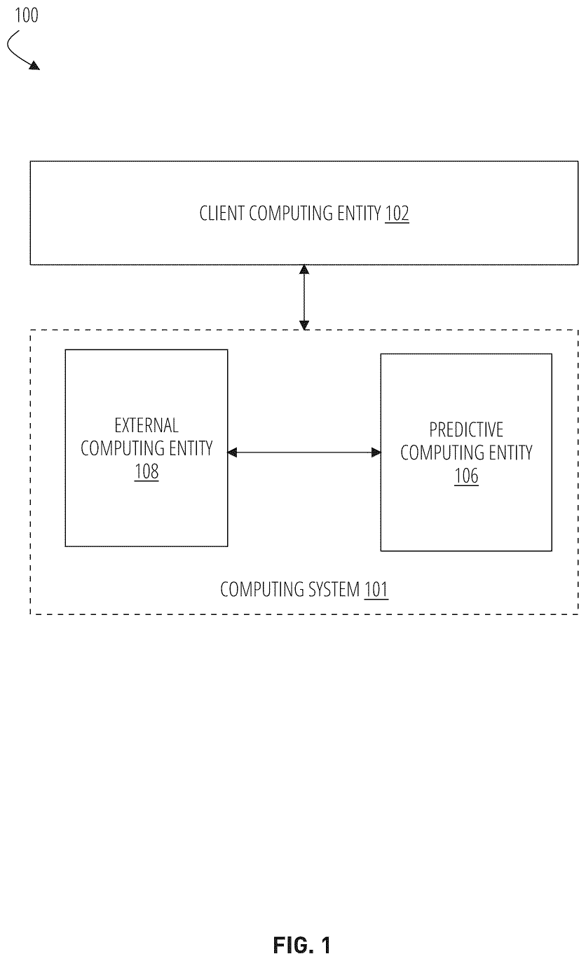

FIG. 1 provides an example overview of an architecture 100 in accordance with some embodiments of the present disclosure. The architecture 100 includes a computing system 101 configured to receive requests, such as signature generation requests, from client computing entities 102, process the requests to generate target classification signatures, and provide the generated signatures to the client computing entities 102. The example architecture 100 may be used in a plurality of domains and not limited to any specific application as disclosed herewith. The plurality of domains may include healthcare, industrial, manufacturing, computer security, to name a few.

In accordance with various embodiments of the present disclosure, one or more machine learning models may be trained to (i) generate target classification probabilities, (ii) extract, cluster, filter, and summarize text segments, and/or the like. The models may form a machine learning pipeline that may be configured to automatically generate signatures for various target classifications. Some techniques of the present disclosure may adapt traditional models to a cohesive framework for more efficiently handling text extraction processes.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive requests from client computing entities 102, process the requests to generate a target classification signatures, and provide the generated signatures to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., embedding techniques, prediction techniques, extraction techniques, summarization techniques, and/or the like) described herein. The external computing entities 108, for example, may include and/or be associated with one or more entities that may be configured to receive, transmit, store, manage, and/or facilitate datasets, such as a labelled training dataset, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

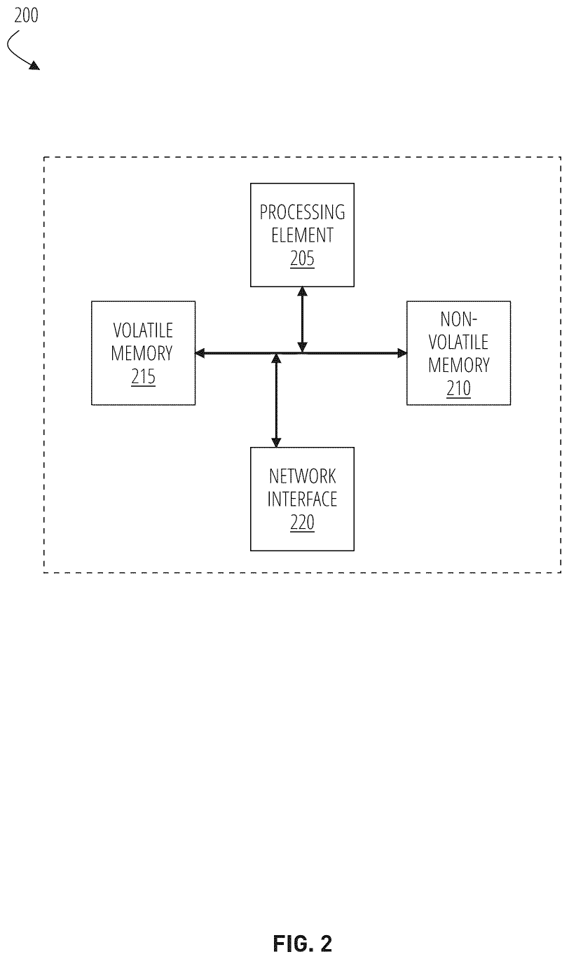

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

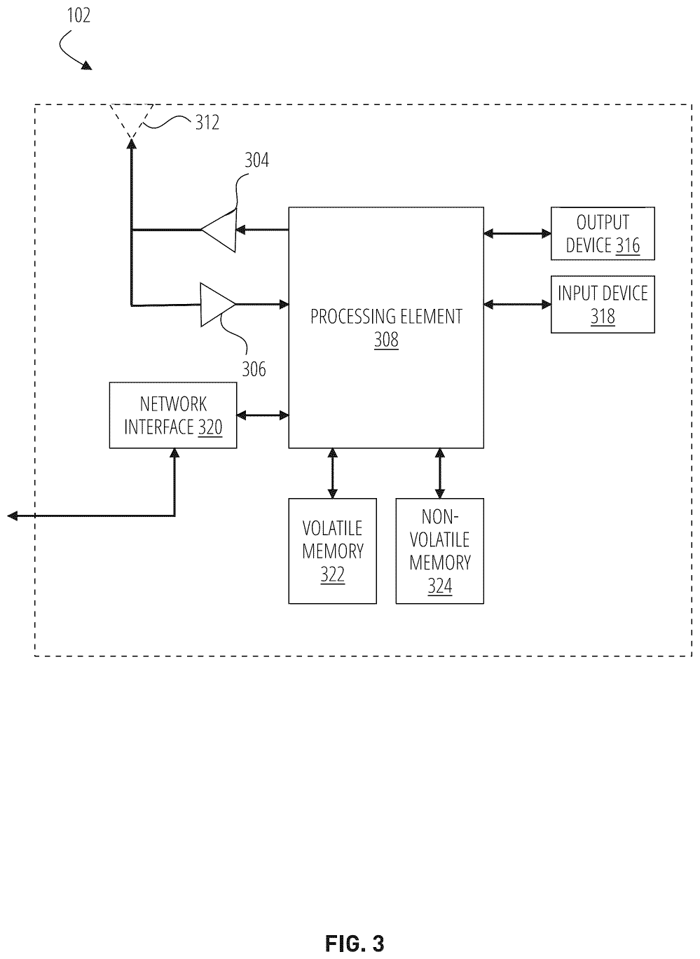

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. EXAMPLES OF CERTAIN TERMS

In some embodiments, the term “target classification” refers to a data entity that describes a prediction outcome for a predictive task. A target classification is domain specific and may include any type of classification for any prediction domain. By way of example, in a clinical domain, a target classification may include disease of interest. Other examples include a vehicle malfunction in a car diagnostic domain, a computer virus in a computer security domain, and/or the like. In some examples, a target classification may be associated with a plurality of text-based objects that may be processed to predict the presence of the target classification in a particular circumstance. Using some of the techniques of the present disclosure, a text-based object may be distilled into textual signatures for the target classification that may thereafter be used to detect the target classification using less processing resources and time than traditionally required. In this way, the techniques of the present disclosure may be applied to any type of target classification to generate textual signatures that may improve the performance of a computer with respect to a variety of predictive tasks, including disease classification, computer virus detection, among others.

In some embodiments, the term “text-based object” refers to a data entity that describes textual data for a target classification. A text-based object is domain specific and may include any type or form of textual information for any prediction domain. By way of example, in a clinical domain, a text-based object may include a clinical note for a patient. Other examples include a vehicle maintenance guide in a car diagnostic domain, a computer virus description in a computer security domain, and/or the like. As described herein, textual data from a text-based object may include a plurality of features of a target classification that are reflected by words or sequences of words within the text. When combined, these features may form signatures of the target classification that may help a computer detect different classifications from text. By way of example, target classification signatures may be used to detect viruses from descriptions of computing activity (e.g., activity logs), diseases from clinical notes, vehicle malfunctions from vehicle maintenance logs, and/or the like.

In some embodiments, the term “labelled training dataset” refers to a data structure that includes labelled data for a machine learning model. A labelled training dataset, for example, may include a plurality of labelled text-based objects. In some examples, the labelled training dataset may be collected from one or more domain-specific databases, real world activity logs, and/or the like. In some examples, the labelled training dataset may include a plurality of labelled text-based objects that are associated with a target classification. For instance, in a clinical domain, the plurality of labelled text-based object may include a plurality of clinical notes, where each note either corresponds to a patient with an associated ICD-code diagnosis of a disease of interest, or not. Other examples may include a plurality of diagnostic reports that either corresponds to computer infected by a virus, or not. In some examples, a status (e.g., diagnosis of a patient, an infection of a computer, etc.) of an entity associated with a labelled text-based object may be used to assign a label to the labelled text-based object. For instance, in the clinical example, a clinical note for a patient diagnosed with a disease may be assigned a binary label for the disease. Similarly, in a computer security example, a diagnostic report for a computer infected by a virus may be assigned a binary label for the virus. In this manner, the labelling techniques of the present disclosure may be applied to any other domain.

In some embodiments, the term “labelled text-based object” refers to a training entry of a labelled training dataset. A labelled text-based object, for example, may include a text-based object and a label corresponding to the text-based object. The label may include a binary label that identifies whether a text-based object (and/or an entity associated therewith) corresponds to a target classification.

In some embodiments, the term “trained classifier model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A trained classifier model may include any type of model configured, trained, and/or the like to generate a target classification probability for a text-based object. A trained classifier model may include one or more of any type of machine learning model including one or more supervised, unsupervised, semi-supervised, reinforcement learning models, and/or the like. In some examples, the trained classifier model may include a machine learning model, such as a neural network, random forest model, naïve bayes classifier, support vector machine, and/or any other machine learning text-based classifier.

In some examples, the trained classifier model may be trained using the labelled training dataset. For example, the trained classifier model may receive, as an input, unstructured text from a labelled text-based object and generate, as an output, a training target classification probability for the labelled text-based object. The training target classification probability may be compared to a label of the labelled text-based object to determine a model loss metric. The trained classifier model may be trained, using back-propagation of errors (or other supervisory training techniques), to optimize the model loss metric. In addition, or alternatively, the trained classifier model may include a language model that is finetuned using the labelled training dataset.

In some examples, the trained classifier model is trained using a portion of the labelled training dataset. For example, the labelled training dataset may be divided into one or more training, testing, and/or evaluation splits. For instance, the labelled training dataset may be divided into a training portion and a testing portion. The trained classifier model may be trained using the training portion and then evaluated (after training) using the testing portion.

In some embodiments, the term “training portion” refers to a portion of the labelled training dataset that is used to train the trained classifier model. The training portion may include any proportion of the labelled training dataset that does not overlap with the testing portion, including ninety-five, seventy, half, and/or the like.

In some embodiments, the term “testing portion” refers to a portion of the labelled training dataset that is used to evaluate the trained classifier model. The testing portion may include any proportion of the labelled training dataset that does not overlap with the training portion, including ninety-five, seventy, half, and/or the like. In some examples, using the techniques of the present disclosure, a plurality of features may be extracted from the testing portion of the labelled training dataset.

In some embodiments, the term “target classification probability” refers to a data entity that describes an output from a trained classifier model. A target classification probability, for example, may include a data value that reflects a likelihood that a text-based object is associated with target classification. By way of example, a target classification probability may include a real number, a percentage, a ratio, and/or the like. In some examples, the target classification probability may include a number between 0 and 1 with a higher number (e.g., closer to 1) indicating a higher likelihood that the text-based object is associated with the target classification. As described herein, a text-based object may be associated with a target classification if the text-based object includes textual evidence of the target classification.

In some embodiments, the term “predictive text-based object” refers to a text-based object that is predictive of a target classification. A predictive text-based object, for example, may include a text-based object that is associated with a target classification probability that satisfies predictive criteria for a target classification. In some examples, the predictive criteria may be defined by a configurable selection parameter.

In some embodiments, the term “configurable selection parameter” refers to a configurable parameter that controls a number of text-based objects that are extracted for a target classification signature. For example, the configurable selection parameter may define a predictive threshold, a relative dataset threshold, and/or the like that defines criteria for selecting a predictive text-based object from a plurality of text-based objects based on a respective plurality of target classification probabilities.

For example, the predictive criteria may define a predictive threshold and a predictive text-based object may include a text-based object that is associated with a target classification probability that satisfies the predictive threshold. For instance, a predictive threshold may define a minimum target classification probability for a text-based object and each text-based object with a target classification probability above the minimum target classification probability may be selected as a predictive text-based object.

In addition, or alternatively, the predictive criteria may define a relative dataset threshold. The relative dataset threshold, for example, may define a percentile of a dataset, such as the testing portion of the labelled training dataset, that may be selected as predictive text-based object. By way of example, the relative dataset threshold may define a top ten percentile threshold and each text-based object with a target classification probability within the top ten percentile may be selected as a predictive text-based object.

In addition, or alternatively, the predictive criteria may define a maximum object threshold and a plurality of predictive text-based objects may be selected up to the maximum object threshold. For instance, a maximum object threshold may define a maximum number of text-based objects that may be selected as predictive text-based object. A text-based object may be selected as a predictive text-based object if the text-based object is associated with target classification probability that is within the maximum object threshold.

In some embodiments, the term “staged prompting mechanism” refers to a sequential prompting technique for extracting data from text. A staged prompting mechanism, for example, may include an automated, interactive, messaging sequence between an automated prompting agent and a generative extraction model. A staged prompting mechanism, for example, may define a sequence of prompts, including a naïve and target classification prompt, that may trigger a sequence of actions from generative extraction model that build upon one another. A first prompt, for example, may trigger a first response from the generative extraction model that may be integrated into a second prompt to the generative extraction model. In this manner, the staged prompting mechanism may define a sequence of interactions between an automated agent and a generative extraction model to iteratively extract information using the generative extraction model. By iteratively extracting information from the generative extraction model, the staged prompting mechanism may replace robust, multi-faceted prompts traditionally used to extract complex information from text and that suffer from several technical challenges including inaccurate hallucinations in text, among other technical deficiencies.

In some embodiments, the term “generative extraction model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative extraction model may include any type of model configured, trained, and/or the like to extract text from text data using a model prompt. A generative extraction model may include one or more of any type of machine learning model including one or more supervised, unsupervised, semi-supervised, reinforcement learning models, and/or the like.

In some examples, the generative extraction model may include a language model, such as a generative pretrained transformer. For instance, generative extraction model may include any type of language model configured to extract text segments from a text corpus. By using the language model with a staged prompting technique, the type of language model may be modifiable and replaced as language models are developed.

In some embodiments, the term “naïve prompt” refers to a broad generative model prompt. A naïve prompt, for example, may include a first prompt, or stage 1 prompt, in a sequence of prompts performed by a staged prompting mechanism. A naïve prompt, for example, may request a list of candidate text segments that may be predictive of a target classification. By way of example, the prompt may include: “Can you find all sentences in this document that provide evidence for <target classification>?”.

In some embodiments, the term “naïve set of explanatory text segments” refers to a model output generated in response to a naïve prompt. A naïve set of explanatory text segments, for example, may include a plurality of candidate text segments that are extracted from a predictive text-based object in response to a naïve prompt.

In some embodiments, the term “target classification prompt” refers to a filtering generative model prompt. A target classification prompt, for example, may include a second prompt, or stage 2 prompt, in a sequence of prompts performed by a staged prompting mechanism. A target classification prompt, for example, may request a list of filtered text segments from an initial list of candidate text segments output responsive to a preceding prompt. For instance, the target classification prompt may request a list of text segments from a naïve set of explanatory text segments. By way of example, the prompt may include: “Given the <naïve set of explanatory text segments> that you extracted, can you only output those that provide evidence for <target classification> and are not negations of <target classification> and are definitely relevant to this <target classification>?”.

In some embodiments, the term “target set of explanatory text segments” refers to a model output generated in response to a target classification prompt. A target set of explanatory text segments, for example, may include a plurality of predictive text segments that are filtered from a naïve set of explanatory text segments in response to a target classification prompt. A target set of explanatory text segments may include plurality of predictive text segments (e.g., sequence of words, sentences, etc.) that include evidence for the target classification. An example predictive text segment for a clinical domain may include the excerpt “Acute pancreatitis (K85.90): Lipase levels elevated but downtrending” from a clinical notes, whereas an example predictive text segment for a computer security domain may include the excerpt “Background Process Name: tlsnuse: 10% CPU 30% Memory 1% Disk 2% Network” from a computer actively log. In some examples, a target set of explanatory text segments may be extracted from each of a plurality of predictive text-based objects extracted from a testing portion of a labelled training dataset.

In some embodiments, the term “target text document” refers to a plurality of target sets of explanatory text segment. A target text document, for example, may include a concatenation of a set of explanatory text segments extracted from each of a plurality of predictive text-based objects to create a single large collection of evidence text segments.

In some embodiments, the term “explanatory embedding” refers to a numerical representation of the target text document. An explanatory embedding, for example, may include a plurality of vectorized explanatory text segments from a target text document that are positioned within a common vector space.

In some embodiments, the term “encoder model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). An encoder model may include any type of model configured, trained, and/or the like to generate an embedded representation from text. An encoder model may include one or more of any type of machine learning model including one or more supervised, unsupervised, semi-supervised, reinforcement learning models, and/or the like. In some examples, the encoder model may include an encoder-only transformer. The encoder model may include any type of encoder-only transformer, such as a pretrained bi-directional encoder representations from transformers (BERT) model, and/or the like. In some examples, the encoder model may include domain-specific encoder-only transformer that is pre-trained on domain specific data.

In some embodiments, the term “semantic segment cluster” refers to a portion of an explanatory embedding that corresponds to one or more semantically related vectorized explanatory text segments. A semantic segment cluster, for example, may include a plurality of vectorized explanatory text segments that are positioned within a threshold distance from one another within vector space. In some examples, a plurality of semantic segment clusters may be identified from vector space using a k-nearest neighbor clustering model. For example, the k-nearest clustering model may be applied in the vector space to assign each vectorized explanatory text segment to one of a plurality of semantic segment clusters. In this manner, a single list of explanatory text segments may be converted into k lists of explanatory text segments respectively corresponding to k semantic segment clusters. In some examples, the number k may be based on a configurable clustering parameter.

In some embodiments, the term “configurable clustering parameter” refers to a configurable parameter that controls a number of clusters identified within a vector space. For example, the configurable clustering parameter may define a threshold value (e.g., 10, 15, 100, etc.). In some examples, the threshold value may include a predefined value that is overestimated such that redundant clusters may be merged post-hoc. In some examples, the threshold value may be dynamically modified to optimize the performance of a target classification signature.

In some embodiments, the term “generative summarization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). A generative summarization model may include any type of model configured, trained, and/or the like to generate an explanatory summary segment from a plurality of explanatory text segments. A generative summarization model may include one or more of any type of machine learning model including one or more supervised, unsupervised, semi-supervised, reinforcement learning models, and/or the like. In some examples, the generative summarization model may include one or more text summarization language models, such as a generative pretrained transformed, large language model, and/or the like.

In some embodiments, the term “explanatory summary segment” refers to a model output generated by a generative summarization model based on a plurality of input explanatory summary segments. An explanatory summary segments, for example, may include a single text segment that summarizes the semantic context from the plurality of input explanatory summary segments. In some examples, an explanatory summary segment may be generated for each of a plurality of semantic segment clusters. For example, given k lists of explanatory text segments, a generative summarization model may summarize each into single sentences to receive k explanatory summary segments. In some examples, the k explanatory summary segments may be leveraged to generate a target classification signature for a target classification. In addition, or alternatively, the k explanatory summary segments may be provided as output to a user and the user may curate a final list of explanatory summary segments for a target classification signature of a target classification.

In some embodiments, the term “target classification signature” refers to a data entity that describes predictive features of a target classification. A target classification signature, for example, may include a collection of words, phrases, data values, and other textual features that may reflect traces of a target classification. In this way, a target classification signature may be used to identity a presence of a target classification without the performance of various resource and time intensive predictive processes. Moreover, in some examples, a target classification signature may be leveraged to improve traditional predictive processes by codifying a plurality of predictive features for a target classification that may be used to train and/or engineer input data for a machine learning model.

A target classification signature may include a plurality of explanatory summary segments. In addition, or alternatively, the target classification signature may include a plurality of words, phrases, data values, and/or other textual features extracted from the plurality of explanatory summary segments.

In some embodiments, the term “prediction-based action” refers to a computing action that is performed using a target classification signature. A prediction-based action is domain specific and may include any physical or virtual action. By way of example, in a clinical domain, a prediction-based action may include one or more health surveillance operations for triggering a clinical action (e.g., a clinical appointment, an emergency operation, etc.) responsive to the detection of a target classification using the target classification signature. Another example may include computer surveillance operations for triggering a security protocol responsive to the detection of a target classification using the target classification signature. In some examples, the prediction-based action may include a physical action. For instance, a target classification signature may be leveraged to identify suspicious activity within a surveilled environment in real time. In such a case, a prediction-based action may include transmitting one or more control instructions to one or more security mechanisms (e.g., alarm systems, door locks, etc.) within the surveilled environment to trigger an alarm, lock a door, and/or the like.

### IV. OVERVIEW

Various embodiments of the present disclosure provide machine learning pipelines that improve computer-based comprehension with respect to target classifications. To do so, some embodiments of the present disclosure provide a multi-stage filtering pipeline that connects a plurality of different, traditionally incompatible, machine learning techniques into a sequence of filtering tasks. To do so, at each of the multi-stage filtering pipeline, the outputs of a machine learning technique are adapted for a subsequent stage. For instance, at a first stage the outputs of a machine learning classifier may be leveraged to filter a set of inputs for a second, large language processing stage. At the second stage, a staged prompting mechanism may be applied with a large language model to extract segments from the pre-filtered set of inputs. The extracted segments may provide to a third stage in which an embedding-based clustering technique is applied to generate predictive clusters from the extracted segments. Finally, the predictive clusters may be passed to a fourth, large language model summarization stage to summarize the clusters into target classification signatures for use in further downstream processes. By doing so, the multi-stage filtering pipeline may adapt a plurality of different machine learning techniques to improve a compatibility between traditionally incompatible computing processes. When used together, the adapted models may form a pipeline for automatically generating target classification signatures from textual features associated with a target classification. This, in turn, allows for the real-time and low resource intensive identification of target classifications within a computing environment. Ultimately, the multi-stage filtering pipeline improves the functionality of a computer with respect to text extraction as well as various detection techniques that may be applied in computing domains, such as computer security (e.g., by detecting the presence of computer viruses, etc.), predictive classification (e.g., by detecting the presence of a prediction, etc.), among others.

Some embodiments of the present disclosure present improved machine learning pipelines for filtering robust sets of text data to generate predictive digital signatures for a particular target classification. The improved pipeline provides a modular framework for connecting traditionally disparate machine learning techniques in a cohesive manner. By doing so, the machine learning pipeline provides a flexible approach that is not constrained to any one model. This allows for model updates over time as new models are developed for each stage of the pipeline.

The modularity of the improve pipeline is achieved, in part, by adapting each model to a particular sub-task within a multi-stage filtering process. This includes adapting a machine learning classifier, traditionally used to generate predictive classifications, to the filtering process. To do so, a machine learning classifier may be trained to generate target classification probabilities using a desired filterable input, such as natural language text. Once trained, the target classification probabilities output by the model may be leveraged to identify the most predictive filterable inputs. For example, higher target classification probabilities may be correlated to filterable inputs with higher predictive significance. This, in turn, allows the classifier model to be applied to a plurality of filterable inputs to extract the most predictive inputs from those input to the model for a second stage of the machine learning pipeline.

Some embodiments of the present disclosure present improved prompting techniques for extracting predictive features from portions of text. For example, the staged prompting mechanism of the present disclosure includes a sequence of staged model prompts that break complex language modelling tasks into simple, nested tasks to prevent hallucinations, inaccuracies, and excess computing resource usage by a large language model. To do so, explanatory text segments are extracted using multiple, nested engineered prompts that are tailored to a particular target classification. A first prompt may include a naïve prompt that is configured to extract an initial naïve set of explanatory text segments from text. The naïve prompt may include a broad-breadth search for predictive text segments that may form the basis for a second, narrow-breadth search for predictive text segments via a target classification prompt. In this manner, the staged prompting mechanism may incrementally extract text segments of increased predictive significant through multiple stages of nested prompts. This, in turn, improves the performance of traditional large language models by providing incremental instruction sets that guide the model's extraction process away from hallucinations, inaccuracies, and undue computing resource usage.

Examples of technologically advantageous embodiments of the present disclosure include: (i) modular machine learning pipelines, (ii) adapted classifier models, (iii) staged prompting mechanisms, among other aspects of the present disclosure. Other technical improvements and advantages may be realized by one of ordinary skill in the art.

### V. EXAMPLE SYSTEM OPERATIONS

As indicated, various embodiments of the present disclosure make important technical contributions to computer-based comprehension. In particular, systems and methods are disclosed herein that implement multi-stage machine learning pipelines to improve machine learning model performance with respect to various tasks, including text extraction for a target classification. By doing so, the multi-stage machine learning pipeline of the present disclosure enables an automated approach to the generation of target classification signatures. This, in turn, may improve the functionality of a computer with respect to various computing tasks, including computer security, classification prediction, and the like, by reducing the time, processing, and memory requirements for completing such tasks.

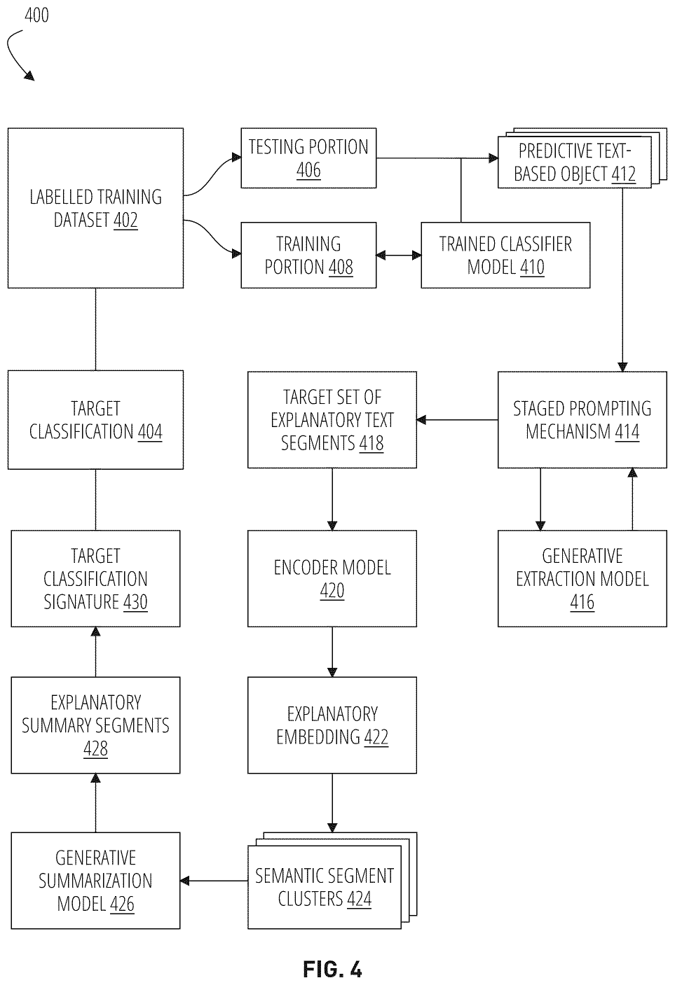

FIG. 4 is a dataflow diagram 400 showing example data structures and modules for generating a target classification signature of a target classification in accordance with some embodiments of the present disclosure. The dataflow diagram 400 shows a modular, multi-stage process that extracts a target classification signatures 430 from a portion of labelled training dataset 402 for a target classification 404. The modular approach may adapt various, traditionally disparate, machine learning techniques to each stage of the process. For instance, using the multi-stage process, a trained classifier model 410, a generative extraction model 416, an encoder model 420, a generative summarization model 426, among others may be connected to sequentially filter predictive features from a labelled training dataset. Ultimately, these features may form a target classification signature 430 that may be used to detect target classification 404 in real time.

In some embodiments, a trained classifier model 410 is trained based on a labelled training dataset 402. The labelled training dataset 402, for example, may include a testing portion 406 and a training portion 408. In some examples, the trained classifier model 410 may be trained, using one or more supervisory training techniques, based on the training portion 408 of the labelled training dataset 402. The trained classifier model 410 may be trained to detect a relevance between a target classification and a text-based object.

In some embodiments, the target classification 404 is a data entity that describes a prediction outcome for a predictive task. A target classification 404 is domain specific and may include any type of classification for any prediction domain. By way of example, in a clinical domain, a target classification 404 may include disease of interest. Other examples include a vehicle malfunction in a car diagnostic domain, a computer virus in a computer security domain, and/or the like. In some examples, a target classification 404 may be associated with a plurality of text-based objects that may be processed to predict the presence of the target classification 404 in a particular circumstance. Using some of the techniques of the present disclosure, a text-based object may be distilled into textual signatures for the target classification 404 that may thereafter be used to detect the target classification 404 using less processing resources and time than traditionally required. In this way, the techniques of the present disclosure may be applied to any type of target classification 404 to generate textual signatures that may improve the performance of a computer with respect to a variety of predictive tasks, including disease classification, computer virus detection, among others.

In some embodiments, the text-based object is a data entity that describes textual data for a target classification 404. A text-based object is domain specific and may include any type or form of textual information for any prediction domain. By way of example, in a clinical domain, a text-based object may include a clinical note for a patient. Other examples include a vehicle maintenance guide in a car diagnostic domain, a computer virus description in a computer security domain, and/or the like. As described herein, textual data from a text-based object may include a plurality of features of a target classification 404 that are reflected by words or sequences of words within the text. When combined, these features may form signatures of the target classification 404 that may help a computer detect different classifications from text. By way of example, target classification signatures 430 may be used to detect viruses from descriptions of computing activity (e.g., activity logs), diseases from clinical notes, vehicle malfunctions from vehicle maintenance logs, and/or the like.

In some embodiments, the labelled training dataset 402 is a data structure that includes labelled data for a machine learning model. The labelled training dataset 402, for example, may include a plurality of labelled text-based objects. In some examples, the labelled training dataset 402 may be collected from one or more domain-specific databases, real world activity logs, and/or the like. In some examples, the labelled training dataset 402 may include a plurality of labelled text-based objects that are associated with a target classification 404. For instance, in a clinical domain, the plurality of labelled text-based object may include a plurality of clinical notes, where each note either corresponds to a patient with an associated ICD-code diagnosis of a disease of interest, or not. Other examples may include a plurality of diagnostic reports that either correspond to a computer infected by a virus, or not. In some examples, a status (e.g., diagnosis of a patient, an infection of a computer, etc.) of an entity associated with a labelled text-based object may be used to assign a label to the labelled text-based object. For instance, in the clinical example, a clinical note for a patient diagnosed with a disease may be assigned a binary label for the disease. Similarly, in a computer security example, a diagnostic report for a computer infected by a virus may be assigned a binary label for the virus. In this manner, the labelling techniques of the present disclosure may be applied to any other domain.

In some embodiments, the labelled text-based object is a training entry of a labelled training dataset. A labelled text-based object, for example, may include a text-based object and a label corresponding to the text-based object. The label may include a binary label that identifies whether a text-based object (and/or an entity associated therewith) corresponds to a target classification.

In some embodiments, the trained classifier model 410 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The trained classifier model 410 may include any type of model configured, trained, and/or the like to generate a target classification probability for a text-based object. A trained classifier model 410 may include one or more of any type of machine learning model including one or more supervised, unsupervised, semi-supervised, reinforcement learning models, and/or the like. In some examples, the trained classifier model 410 may include a machine learning model, such as a neural network, random forest model, naïve bayes classifier, support vector machine, and/or any other machine learning text-based classifier.

In some examples, the trained classifier model 410 may be trained using the labelled training dataset 402. For example, the trained classifier model 410 may receive, as an input, unstructured text from a labelled text-based object and generate, as an output, a training target classification probability for the labelled text-based object. The training target classification probability may be compared to a label of the labelled text-based object to determine a model loss metric. The trained classifier model 410 may be trained, using back-propagation of errors (or other supervisory training techniques), to optimize the model loss metric. In addition, or alternatively, the trained classifier model 410 may include a language model that is finetuned using the labelled training dataset 402.

In some examples, the trained classifier model 410 is trained using a portion of the labelled training dataset 402. For example, the labelled training dataset 402 may be divided into one or more training, testing, and/or evaluation splits. For instance, the labelled training dataset 402 may be divided into a training portion 408 and a testing portion 406. The trained classifier model 410 may be trained using the training portion 408 and then evaluated (after training) using the testing portion 406.

In some embodiments, the training portion 408 is a portion of the labelled training dataset 402 that is used to train the trained classifier model 410. The training portion 408 may include any proportion of the labelled training dataset 402 that does not overlap with the testing portion 406, including ninety-five, seventy, half, and/or the like.

In some embodiments, the testing portion 406 is a portion of the labelled training dataset 402 that is used to evaluate the trained classifier model 410. The testing portion 406 may include any proportion of the labelled training dataset 402 that does not overlap with the training portion 408, including ninety-five, seventy, half, and/or the like. In some examples, using the techniques of the present disclosure, a plurality of features may be extracted from the testing portion 406 of the labelled training dataset 402.

In some embodiments, a plurality of target classification probabilities is generated for a plurality of labelled text-based objects from the testing portion 406 of the labelled training dataset 402. In some examples, the plurality of target classification probabilities may be generated using the trained classifier model 410.

In some embodiments, the target classification probability is a data entity that describes an output from the trained classifier model 410. A target classification probability, for example, may include a data value that reflects a likelihood that a text-based object is associated with the target classification 404. By way of example, a target classification probability may include a real number, a percentage, a ratio, and/or the like. In some examples, the target classification probability may include a number between 0 and 1 with a higher number (e.g., closer to 1) indicating a higher likelihood that the text-based object is associated with the target classification 404. As described herein, a text-based object may be associated with a target classification 404 if the text-based object includes textual evidence of the target classification 404.

In some embodiments, one or more predictive text-based objects 412 are identified from the plurality of labelled text-based objects based on the plurality of target classification probabilities. In some examples, the one or more predictive text-based objects may be associated with a top ten percentile of the plurality of target classification probabilities.

In some embodiments, the predictive text-based object 412 is a text-based object that is predictive of the target classification 404. The predictive text-based object 412, for example, may include a text-based object that is associated with a target classification probability that satisfies predictive criteria for the target classification 404. In some examples, the predictive criteria may be defined by a configurable selection parameter.

In some embodiments, the configurable selection parameter is a configurable parameter that controls a number of text-based objects that are extracted for a target classification signature 430. For example, the configurable selection parameter may define a predictive threshold, a relative dataset threshold, and/or the like that defines criteria for selecting a predictive text-based object 412 from a plurality of text-based objects based on a respective plurality of target classification probabilities.

For example, the predictive criteria may define a predictive threshold and a predictive text-based object 412 may include a text-based object that is associated with a target classification probability that satisfies the predictive threshold. For instance, a predictive threshold may define a minimum target classification probability for a text-based object and each text-based object with a target classification probability above the minimum target classification probability may be selected as a predictive text-based object 412.

In addition, or alternatively, the predictive criteria may define a relative dataset threshold. The relative dataset threshold, for example, may define a percentile of a dataset, such as the testing portion 406 of the labelled training dataset 402, that may be selected as predictive text-based objects 412. By way of example, the relative dataset threshold may define a top ten percentile threshold and each text-based object with a target classification probability within the top ten percentile may be selected as a predictive text-based object 412.

In addition, or alternatively, the predictive criteria may define a maximum object threshold and a plurality of predictive text-based objects 412 may be selected up to the maximum object threshold. For instance, a maximum object threshold may define a maximum number of text-based objects that may be selected as predictive text-based objects 412. A text-based object may be selected as a predictive text-based object 412 if the text-based object is associated with target classification probability that is within the maximum object threshold.

In some embodiments, a target set of explanatory text segments 418 is identified from the one or more predictive text-based objects. The target set of explanatory text segments 418 may be identified by applying a staged prompting mechanism 414 to a generative extraction model 416.

In some embodiments, the staged prompting mechanism 414 is a sequential prompting technique for extracting data from text. The staged prompting mechanism 414, for example, may include an automated, interactive, messaging sequence between an automated prompting agent and a generative extraction model 416. The staged prompting mechanism 414, for example, may define a sequence of prompts, including a naïve and target classification prompt, that may trigger a sequence of actions from generative extraction model 416 that build upon one another. A first prompt, for example, may trigger a first response from the generative extraction model 416 that may be integrated into a second prompt to the generative extraction model 416. In this manner, the staged prompting mechanism 414 may define a sequence of interactions between an automated agent and a generative extraction model 416 to iteratively extract information using the generative extraction model 416. By iteratively extracting information from the generative extraction model 416, the staged prompting mechanism 414 may replace robust, multi-faceted prompts traditionally used to extract complex information from text and that suffer from several technical challenges including inaccurate hallucinations in text, among other technical deficiencies.

In some embodiments, the generative extraction model 416 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The generative extraction model 416 may include any type of model configured, trained, and/or the like to extract text from text data using a model prompt. A generative extraction model 416 may include one or more of any type of machine learning model including one or more supervised, unsupervised, semi-supervised, reinforcement learning models, and/or the like.

In some examples, the generative extraction model 416 may include a language model, such as a generative pretrained transformer. For instance, generative extraction model 416 may include any type of language model configured to extract text segments from a text corpus. By using the language model with a staged prompting technique, the type of language model may be modifiable and replaced as language models are developed.

In some embodiments, the target set of explanatory text segments 418 is a plurality of model outputs generated using the staged prompting mechanism 414. A target set of explanatory text segments 418 may include plurality of predictive text segments (e.g., sequence of words, sentences, etc.) that include evidence for the target classification 404. An example predictive text segment for a clinical domain may include the excerpt “Acute pancreatitis (K85.90): Lipase levels elevated but downtrending” from a clinical notes, whereas an example predictive text segment for a computer security domain may include the excerpt “Background Process Name: tlsnuse: 10% CPU 30% Memory 1% Disk 2% Network” from a computer actively log. In some examples, a target set of explanatory text segments 418 may be extracted from each of a plurality of predictive text-based objects extracted from the testing portion 406 of the labelled training dataset 402.

In some embodiments, one or more semantic segment clusters 424 are generated from the target set of explanatory text segments. For example, an explanatory embedding 422 may be generated using an encoder model 420 based on the target set of explanatory text segments. For instance, a target text document may be generated by concatenating the target set of explanatory text segments 418 from the one or more predictive text-based objects 412 and transforming, using the encoder model 420, the target text document into the explanatory embedding 422. The one or more semantic segment clusters 424 may be generated based on the explanatory embedding 422.

In some embodiments, the target text document is a plurality of target sets of explanatory text segments 418. A target text document, for example, may include a concatenation of a set of explanatory text segments extracted from each of a plurality of predictive text-based objects to create a single large collection of evidence text segments.

In some embodiments, the explanatory embedding 422 is a numerical representation of the target text document. An explanatory embedding 422, for example, may include a plurality of vectorized explanatory text segments from a target text document that are positioned within a common vector space.

In some embodiments, the encoder model 420 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The encoder model 420 may include any type of model configured, trained, and/or the like to generate an embedded representation from text. The encoder model 420 may include one or more of any type of machine learning model including one or more supervised, unsupervised, semi-supervised, reinforcement learning models, and/or the like. In some examples, the encoder model 420 may include an encoder-only transformer. The encoder model 420 may include any type of encoder-only transformer, such as a pretrained bi-directional encoder representations from transformers (BERT) model, and/or the like. In some examples, the encoder model 420 may include domain-specific encoder-only transformer that is pre-trained on domain specific data.

In some embodiments, the semantic segment cluster 424 is a portion of an explanatory embedding 422 that corresponds to one or more semantically related vectorized explanatory text segments. A semantic segment cluster 424, for example, may include a plurality of vectorized explanatory text segments that are positioned within a threshold distance from one another within vector space. In some examples, a plurality of semantic segment clusters 424 may be identified from vector space using a k-nearest neighbor clustering model. For example, the k-nearest clustering model may be applied in the vector space to assign each vectorized explanatory text segment to one of a plurality of semantic segment clusters 424. In this manner, a single list of explanatory text segments may be converted into k lists of explanatory text segments respectively corresponding to k semantic segment clusters 424. In some examples, the number k may be based on a configurable clustering parameter.

In some embodiments, a number of the one or more semantic segment clusters 424 is based on a configurable clustering parameter. The plurality of semantic segment clusters 424 may be generated, using a k-nearest neighbor clustering algorithm, based on the configurable clustering parameter.

In some embodiments, the configurable clustering parameter is a configurable parameter that controls a number of clusters identified within a vector space. For example, the configurable clustering parameter may define a threshold value (e.g., 10, 15, 100, etc.). In some examples, the threshold value may include a predefined value that is overestimated such that redundant clusters may be merged post-hoc. In some examples, the threshold value may be dynamically modified to optimize the performance of the target classification signature 430.

In some embodiments, one or more explanatory summary segments 428 are generated that respectively correspond to the one or more semantic segment clusters 424. The explanatory summary segments 428 may be generated using a generative summarization model 426. The generative extraction model 416, for example, may include a generative pre-trained transformer.

In some embodiments, the generative summarization model 426 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The generative summarization model 426 may include any type of model configured, trained, and/or the like to generate an explanatory summary segment 428 from a plurality of explanatory text segments. A generative summarization model 426 may include one or more of any type of machine learning model including one or more supervised, unsupervised, semi-supervised, reinforcement learning models, and/or the like. In some examples, the generative summarization model 426 may include one or more text summarization language models, such as a generative pretrained transformed, large language model, and/or the like.

In some embodiments, the explanatory summary segment is a model output generated by a generative summarization model 426 based on a plurality of input explanatory summary segments. An explanatory summary segment 428, for example, may include a single text segment that summarizes the semantic context from the plurality of input explanatory summary segments. In some examples, an explanatory summary segment 428 may be generated for each of a plurality of semantic segment clusters 424. For example, given k lists of explanatory text segments, a generative summarization model 426 may summarize each into single sentences to receive k explanatory summary segments 428. In some examples, the k explanatory summary segments 428 may be leveraged to generate a target classification signature 430 for a target classification 404. In addition, or alternatively, the k explanatory summary segments 428 may be provided as output to a user and the user may curate a final list of explanatory summary segments 428 for a target classification signature 430 of a target classification 404.

In some embodiments, a target classification signature 430 is generated based on a plurality of words from the one or more explanatory summary segments 428. For example, one or more of the plurality of words may be extracted from each of the one or more explanatory summary segments 428. The plurality of words may be concatenated to form the target classification signature 430. In some examples, storing the target classification signature 430 in association with the trained classifier model 410.

In some embodiments, the target classification signature 430 is a data entity that describes predictive features of the target classification 404. The target classification signature 430, for example, may include a collection of words, phrases, data values, and other textual features that may reflect traces of the target classification 404. In this way, the target classification signature 430 may be used to identity a presence of the target classification 404 without the performance of various resource and time intensive predictive processes. Moreover, in some examples, the target classification signature 430 may be leveraged to improve traditional predictive processes by codifying a plurality of predictive features for the target classification 404 that may be used to train and/or engineer input data for a machine learning model.

The target classification signature 430 may include a plurality of explanatory summary segments 428. In addition, or alternatively, the target classification signature 430 may include a plurality of words, phrases, data values, and/or other textual features extracted from the plurality of explanatory summary segments 428.

In some embodiments, a prediction-based action is initiated based on the target classification signature 430. In some examples, a plurality of entities may be identified that correspond to the target classification 404 based on a comparison between the target classification signature 430 and a plurality of text-based objects respectively corresponding to the plurality of entities.

In some embodiments, the prediction-based action is a computing action that is performed using the target classification signature 430. The prediction-based action is domain specific and may include any physical or virtual action. By way of example, in a clinical domain, a prediction-based action may include one or more health surveillance operations for triggering a clinical action (e.g., a clinical appointment, an emergency operation, etc.) responsive to the detection of the target classification 404 using the target classification signature 430. Another example may include computer surveillance operations for triggering a security protocol responsive to the detection of a target classification 404 using the target classification signature 430. In some examples, the prediction-based action may include a physical action. For instance, a target classification signature 430 may be leveraged to identify suspicious activity within a surveilled environment in real time. In such a case, a prediction-based action may include transmitting one or more control instructions to one or more security mechanisms (e.g., alarm systems, door locks, etc.) within the surveilled environment to trigger an alarm, activate a smart lock, and/or the like.

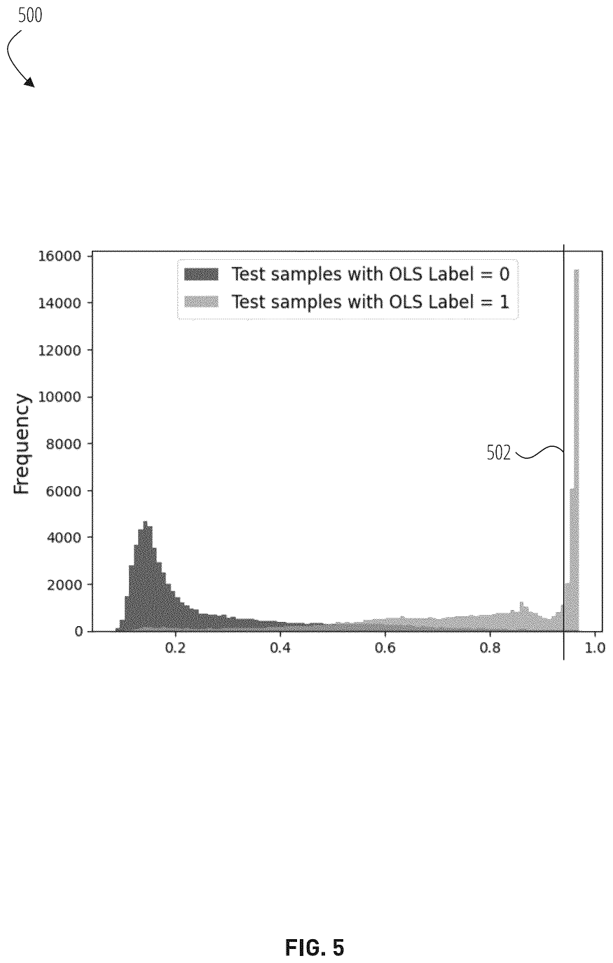

FIG. 5 is an operational example 500 of an initial extraction phase from a labelled training dataset in accordance with some embodiments of the present disclosure. The operational example 500 shows a graph that describes a frequency of a plurality of target classification probabilities within a testing portion of a labelled training dataset. In some examples, a configurable selection parameter 502 may be set as a function of the frequency of a plurality of target classification probabilities to remove noise from the dataset without losing predictive features from the dataset. By way of example, a configurable selection parameter 502 may be set below a drop-off in frequency to capture predictive features while removing noise.

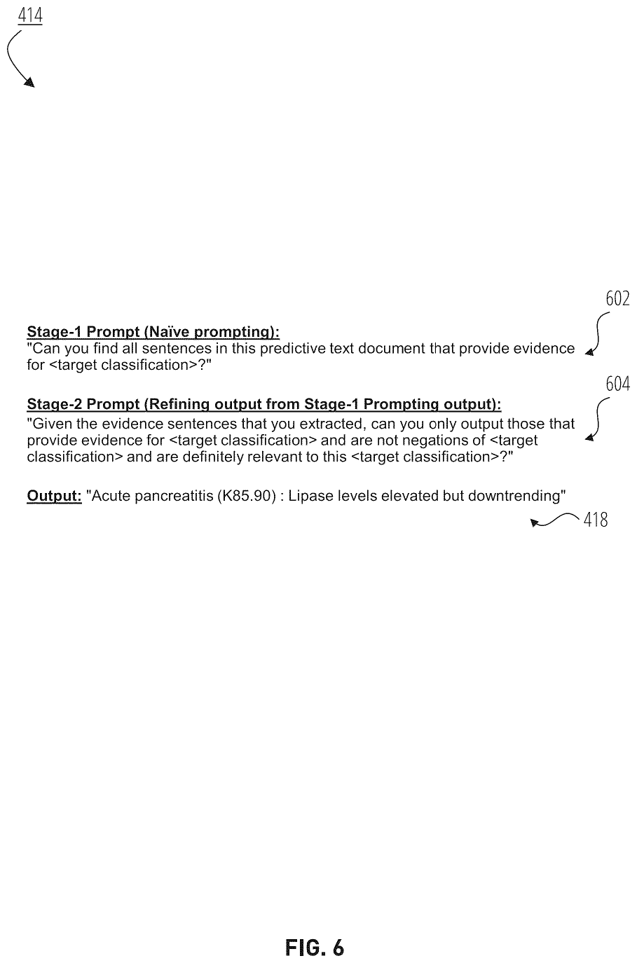

FIG. 6 is an operational example of a staged prompting mechanism 414 in accordance with some embodiments of the present disclosure. The staged prompting mechanism 414 may include a sequence of prompts that build upon one another to extract evidence from text in a controlled manner that reduces hallucinations in generative model outputs. For example, by breaking a complex computing task into staged prompts, the staged prompting mechanism 414 may extract details from text using simple prompts that discourage hallucinations, while incrementally advancing the model toward complex details that are traditionally subject to hallucinations.

In some embodiments, the staged prompting mechanism 414 includes a naïve prompt 602 and a target classification prompt 604. In some examples, the staged prompting mechanism 414 may input, to a generative extraction model, the naïve prompt 602 for a target classification to identify a naïve set of explanatory text segments from the one or more predictive text-based objects.

In some embodiments, the naïve prompt 602 is a broad generative model prompt. A naïve prompt 602, for example, may include a first prompt, or stage 1 prompt, in a sequence of prompts performed by a staged prompting mechanism 414. The naïve prompt 602 may request a list of candidate text segments that may be predictive of a target classification. By way of example, the prompt may include: “Can you find all sentences in this document that provide evidence for <target classification>?”.

In some embodiments, the naïve set of explanatory text segments include model outputs generated in response to the naïve prompt 602. The naïve set of explanatory text segments, for example, may include a plurality of candidate text segments that are extracted from a predictive text-based object in response to the naïve prompt 602.

In some embodiments, the staged prompting mechanism 414 generates a target classification prompt 604 based on the naïve set of explanatory text segments. The staged prompting mechanism 414 may input, to the generative extraction model, the target classification prompt 604 to identify a target set of explanatory text segments 418 from the naïve set of explanatory text segments.

In some embodiments, the target classification prompt 604 is a filtering generative model prompt. A target classification prompt 604, for example, may include a second prompt, or stage 2 prompt, in a sequence of prompts performed by the staged prompting mechanism 414. The target classification prompt 604, for example, may request a list of filtered text segments from an initial list of candidate text segments output responsive to a preceding prompt. For instance, the target classification prompt 604 may request a list of text segments from a naïve set of explanatory text segments. By way of example, the prompt may include: “Given the <naïve set of explanatory text segments> that you extracted, can you only output those that provide evidence for <target classification> and are not negations of <target classification> and are definitely relevant to this <target classification>?”. The resulting target set of explanatory text segments 418, for example, may include a plurality of predictive text segments that are filtered from the naïve set of explanatory text segments in response to the target classification prompt 604.

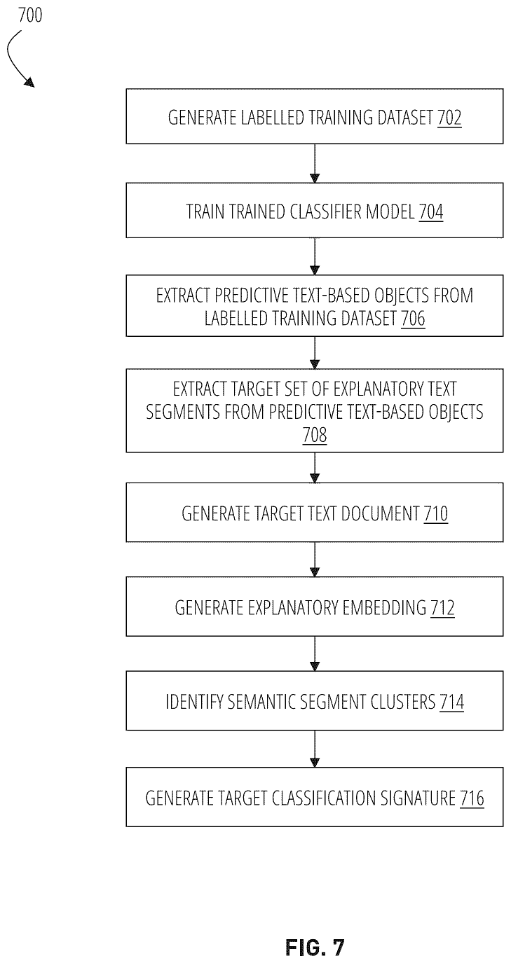

FIG. 7 is a flowchart diagram of an example process for generating a target classification signature of a target classification in accordance with some embodiments of the present disclosure. The flowchart depicts a data processing technique that leverages a new multi-stage machine learning pipeline to extract signatures for a target classification. The process 700 may be implemented by one or more computing devices, entities, and/or systems described herein. For example, via the various steps/operations of the process 700, the computing system 101 may leverage improved model pipelines and adapted machine learning model to interpret and extract entities from a robust set of text data. By doing so, the process 700 enables the automated generation of target classification signatures that may be used to replace downstream computer resource intensive machine learning detection operations with simple, less intensive text matching processes.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 may include a multi-stage machine learning pipeline in which one or more operations are performed at each of a plurality stages to iteratively extract a sequence of words for the creation of a target classification signature.

In some embodiments, prior to a first stage of the machine learning pipeline, the process 700 includes, at step/operation 702, generating a labelled training dataset. For example, the computing system 101 may generate the labelled training dataset by collecting a plurality of text-based objects associated with a target classification. Each text-based object of the labelled training dataset may be labelled using a target classification associated with an entity corresponding to the text-based object.

In some embodiments, the process 700 includes, at step/operation 704, training a trained classifier model. For example, the computing system 101 may train the trained classifier model using a training portion of the labelled training dataset. In some examples, the computing system 101 may previously train the trained classifier model, using one or more supervisory training techniques, based on the training portion of the labelled training dataset.

In some embodiments, at a first stage of the machine learning pipeline, the process 700 includes, at step/operation 706, extracting predictive text-based objects from the labelled training dataset. For example, the computing system 101 may generate, using the trained classifier model, a plurality of target classification probabilities for a plurality of labelled text-based objects from a testing portion of the labelled training dataset. The computing system 101 may identify, at the first stage, one or more predictive text-based objects from the plurality of labelled text-based objects based on the plurality of target classification probabilities. For instance, the one or more predictive text-based objects may be associated with a top ten percentile of the plurality of target classification probabilities.

In some embodiments, at a second stage of the of the machine learning pipeline, the process 700 includes, at step/operation 708, extracting a target set of explanatory text segments from the predictive text-based objects. For example, the computing system 101 may identify at the second stage, via staged prompting to a generative extraction model, a target set of explanatory text segments from the one or more predictive text-based objects. For example, the computing system 101 may input, to a generative extraction model, a naïve prompt for a target classification to identify a naïve set of explanatory text segments from the one or more predictive text-based objects. The computing system 101 may generate a target classification prompt based on the naïve set of explanatory text segments and input, to the generative extraction model, the target classification prompt to identify a target set of explanatory text segments from the naïve set of explanatory text segments. In some examples, the generative extraction model is a generative pre-trained transformer.

In some embodiments, the process 700 includes, at step/operation 710, generating a target text document. For example, the computing system 101 may generate the target text document by concatenating the target set of explanatory text segments from the one or more predictive text-based objects.

In some embodiments, the process 700 includes, at step/operation 712, generating an explanatory embedding. For example, the computing system 101 may generate, using an encoder model, the explanatory embedding based on the target set of explanatory text segments. In some examples, the computing system 101 may transform, using the encoder model, the target text document into the explanatory embedding.

In some embodiments, the process 700 includes, at step/operation 714, identifying a semantic segment cluster. For example, the computing system 101 may generate one or more semantic segment clusters from the target set of explanatory text segments. For instance, the computing system 101 may generate the one or more semantic segment clusters based on the explanatory embedding. In some examples, the number of the one or more semantic segment clusters may be based on a configurable clustering parameter. For example, the computing system 101 may generate, using a k-nearest neighbor clustering algorithm, the one or more semantic segment clusters based on the configurable clustering parameter.

In some embodiments, at a third stage of the of the machine learning pipeline, the process 700 includes, at step/operation 716, generating a target classification signature. For example, the computing system 101 may generate, using a generative summarization model, one or more explanatory summary segments respectively corresponding to the one or more semantic segment clusters. The computing system 101 may extract, at the third stage, a sequence of words from the one or more explanatory summary segments to generate a target classification signature. In some examples, the sequence of words may be extracted from each of the one or more explanatory summary segments and concatenated to form the target classification signature. In some examples, the computing system 101 may store the target classification signature in association with the trained classifier model.

In some embodiments, the computing system 101 initiates a prediction-based action based on the target classification signature. For instance, the computing system 101 may identify a plurality of entities that correspond to a target classification based on a comparison between the target classification signature and a plurality of text-based objects respectively corresponding to the plurality of entities. The computing system 101 may perform one or more actions with respect to one or more of the plurality of entities.

For instance, some techniques of the present disclosure enable the generation of action outputs that may be performed to initiate one or more real world actions to achieve real-world effects. The techniques of the present disclosure may be used, applied, and/or otherwise leveraged to identify entities using textual signatures, and/or the like, which may help in various downstream tasks including virus screening, clinical screening, and/or the like. For instance, the action outputs may include automated investigation actions that may trigger the performance of actions at a client device, such as the display, transmission, and/or the like of data reflective of investigation parameters (e.g., virus detection, patient detection, malfunction detection, etc.). In some embodiments, investigation parameters may trigger an alert, and/or the like. The alert may be automatically communicated to a user and/or be used to initiate a security protocol (e.g., locking a computer, etc.), a robotic action (e.g., performing an automated vehicle maintenance action, etc.), and/or the like.

In some examples, the computing tasks may include actions that may be based on a prediction domain. A prediction domain may include any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may include the initiation of automated instructions across and between devices, automated notifications, automated scheduling operations, automated precautionary actions, automated security actions, automated data processing actions, and/or the like.

### VI. CONCLUSION

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising generating, by one or more processors and using a trained classifier model, a plurality of target classification probabilities for a plurality of labelled text-based objects from a testing portion of a labelled training dataset; identifying at a first stage, by the one or more processors, one or more predictive text-based objects from the plurality of labelled text-based objects based on the plurality of target classification probabilities; identifying at a second stage, by the one or more processors and via staged prompting to a generative extraction model, a target set of explanatory text segments from the one or more predictive text-based objects; generating, by the one or more processors, one or more semantic segment clusters from the target set of explanatory text segments; generating, by the one or more processors and using a generative summarization model, one or more explanatory summary segments respectively corresponding to the one or more semantic segment clusters; extracting at a third stage, by the one or more processors, a sequence of words from the one or more explanatory summary segments to generate a target classification signature; and storing, by the one or more processors, the target classification signature in association with a target classification.

Example 2. The computer-implemented method of example 1, wherein the trained classifier model is previously trained, using one or more supervisory training techniques, based on a training portion of the labelled training dataset.

Example 3. The computer-implemented method of any of the preceding examples, wherein the one or more predictive text-based objects are associated with a top ten percentile of the plurality of target classification probabilities.

Example 4. The computer-implemented method of any of the preceding examples, wherein generating the one or more semantic segment clusters from the target set of explanatory text segments comprises generating, using an encoder model, an explanatory embedding based on the target set of explanatory text segments; and generating the one or more semantic segment clusters based on the explanatory embedding.

Example 5. The computer-implemented method of example 4, wherein generating the explanatory embedding comprises generating a target text document by concatenating the target set of explanatory text segments from the one or more predictive text-based objects; and transforming, using the encoder model, the target text document into the explanatory embedding.

Example 6. The computer-implemented method of examples 4 or 5, wherein a number of the one or more semantic segment clusters is based on a configurable clustering parameter and generating the one or more semantic segment clusters comprises generating, using a k-nearest neighbor clustering algorithm, the one or more semantic segment clusters based on the configurable clustering parameter.

Example 7. The computer-implemented method of any of the preceding examples, wherein the staged prompting comprises inputting, to the generative extraction model, a naïve prompt for the target classification to identify a naïve set of explanatory text segments from the one or more predictive text-based objects; generating a target classification prompt based on the naïve set of explanatory text segments; and inputting, to the generative extraction model, the target classification prompt to identify the target set of explanatory text segments from the naïve set of explanatory text segments.

Example 8. The computer-implemented method of example 7, wherein the generative extraction model comprises a generative pre-trained transformer.

Example 9. The computer-implemented method of any of the preceding examples, further comprising initiating a prediction-based action based on the target classification signature by identifying a plurality of entities that correspond to the target classification based on a comparison between the target classification signature and a plurality of text-based objects respectively corresponding to the plurality of entities.

Example 10. The computer-implemented method of any of the preceding examples, wherein generating the target classification signature comprises extracting one or more of the sequence of words from each of the one or more explanatory summary segments; and concatenating the sequence of words to form the target classification signature.

Example 11. A system comprising memory and one or more processors communicatively coupled to the memory, the one or more processors configured to generate, using a trained classifier model, a plurality of target classification probabilities for a plurality of labelled text-based objects from a testing portion of a labelled training dataset; identify at a first stage, one or more predictive text-based objects from the plurality of labelled text-based objects based on the plurality of target classification probabilities; identify at a second stage, via staged prompting to a generative extraction model, a target set of explanatory text segments from the one or more predictive text-based objects; generate one or more semantic segment clusters from the target set of explanatory text segments; generate, using a generative summarization model, one or more explanatory summary segments respectively corresponding to the one or more semantic segment clusters; extract at a third stage, a sequence of words from the one or more explanatory summary segments to generate a target classification signature; and store the target classification signature in association with a target classification.

Example 12. The system of example 11, wherein the trained classifier model is previously trained, using one or more supervisory training techniques, based on a training portion of the labelled training dataset.

Example 13. The system of any of examples 11 through 12, wherein the one or more predictive text-based objects are associated with a top ten percentile of the plurality of target classification probabilities.

Example 14. The system of any of examples 11 through 13, wherein generating the one or more semantic segment clusters from the target set of explanatory text segments comprises generating, using an encoder model, an explanatory embedding based on the target set of explanatory text segments; and generating the one or more semantic segment clusters based on the explanatory embedding.

Example 15. The system of any of examples 11 through 14, wherein generating the explanatory embedding comprises generating a target text document by concatenating the target set of explanatory text segments from the one or more predictive text-based objects; and transforming, using the encoder model, the target text document into the explanatory embedding.

Example 16. The system of any of examples 11 through 15, wherein a number of the one or more semantic segment clusters is based on a configurable clustering parameter and generating the one or more semantic segment clusters comprises generating, using a k-nearest neighbor clustering algorithm, the one or more semantic segment clusters based on the configurable clustering parameter.

Example 17. The system of any of examples 11 through 16, wherein the staged prompting comprises inputting, to the generative extraction model, a naïve prompt for the target classification to identify a naïve set of explanatory text segments from the one or more predictive text-based objects; generating a target classification prompt based on the naïve set of explanatory text segments; and inputting, to the generative extraction model, the target classification prompt to identify the target set of explanatory text segments from the naïve set of explanatory text segments.

Example 18. One or more non-transitory computer-readable storage media including instructions that, when executed by one or more processors, cause the one or more processors to generate, using a trained classifier model, a plurality of target classification probabilities for a plurality of labelled text-based objects from a testing portion of a labelled training dataset; identify at a first stage, one or more predictive text-based objects from the plurality of labelled text-based objects based on the plurality of target classification probabilities; identify at a second stage, via staged prompting to a generative extraction model, a target set of explanatory text segments from the one or more predictive text-based objects; generate one or more semantic segment clusters from the target set of explanatory text segments; generate, using a generative summarization model, one or more explanatory summary segments respectively corresponding to the one or more semantic segment clusters; extract at a third stage, a sequence of words from the one or more explanatory summary segments to generate a target classification signature; and store the target classification signature in association with a target classification.

Example 19. The one or more non-transitory computer-readable storage media of claim 18, wherein the trained classifier model is previously trained, using one or more supervisory training techniques, based on a training portion of the labelled training dataset.

Example 20. The one or more non-transitory computer-readable storage media of examples 18 or 19, wherein initiating the prediction-based action based on the target classification signature comprises identifying a plurality of entities that correspond to a target classification based on a comparison between the target classification signature a plurality of text-based objects respectively corresponding to the plurality of entities.

Example 21. The computer-implemented method of example 1, wherein the method further comprises training the trained classifier model, the generative extraction model, the encoder model, and the generative summarization model.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 12, wherein the one or more processors are further configured to train the trained classifier model, the generative extraction model, the encoder model, and the generative summarization model.

Example 25. The computing system of example 24, wherein the one or more processors are included in a first computing entity; and the trained classifier model, the generative extraction model, the encoder model, and the generative summarization model are trained by one or more other processors included in a second computing entity.

Example 26. The one or more non-transitory computer-readable storage media of example 19, wherein the instructions further cause the one or more processors to train the trained classifier model, the generative extraction model, the encoder model, and the generative summarization model.

Example 27. The one or more non-transitory computer-readable storage media of example 26, wherein the one or more processors are included in a first computing entity; and the trained classifier model, the generative extraction model, the encoder model, and the generative summarization model are trained by one or more other processors included in a second computing entity.

1. A computer-implemented method comprising:
generating, by one or more processors and using a trained classifier model, a plurality of target classification probabilities for a plurality of labelled text-based objects from a testing portion of a labelled training dataset;
identifying at a first stage, by the one or more processors, one or more predictive text-based objects from the plurality of labelled text-based objects based on the plurality of target classification probabilities;
identifying at a second stage, by the one or more processors and via staged prompting to a generative extraction model, a target set of explanatory text segments from the one or more predictive text-based objects;
generating, by the one or more processors, one or more semantic segment clusters from the target set of explanatory text segments;
generating, by the one or more processors and using a generative summarization model, one or more explanatory summary segments respectively corresponding to the one or more semantic segment clusters;
extracting at a third stage, by the one or more processors, a sequence of words from the one or more explanatory summary segments to generate a target classification signature; and
storing, by the one or more processors, the target classification signature in association with a target classification.

2. The computer-implemented method of claim 1, wherein the trained classifier model is previously trained, using one or more supervisory training techniques, based on a training portion of the labelled training dataset.

3. The computer-implemented method of claim 1, wherein the one or more predictive text-based objects are associated with a top ten percentile of the plurality of target classification probabilities.

4. The computer-implemented method of claim 1, wherein generating the one or more semantic segment clusters from the target set of explanatory text segments comprises:
generating, using an encoder model, an explanatory embedding based on the target set of explanatory text segments; and
generating the one or more semantic segment clusters based on the explanatory embedding.

5. The computer-implemented method of claim 4, wherein generating the explanatory embedding comprises:
generating a target text document by concatenating the target set of explanatory text segments from the one or more predictive text-based objects; and
transforming, using the encoder model, the target text document into the explanatory embedding.

6. The computer-implemented method of claim 4, wherein a number of the one or more semantic segment clusters is based on a configurable clustering parameter and generating the one or more semantic segment clusters comprises:
generating, using a k-nearest neighbor clustering algorithm, the one or more semantic segment clusters based on the configurable clustering parameter.

7. The computer-implemented method of claim 1, wherein the staged prompting comprises:
inputting, to the generative extraction model, a naïve prompt for the target classification to identify a naïve set of explanatory text segments from the one or more predictive text-based objects;
generating a target classification prompt based on the naïve set of explanatory text segments; and
inputting, to the generative extraction model, the target classification prompt to identify the target set of explanatory text segments from the naïve set of explanatory text segments.

8. The computer-implemented method of claim 7, wherein the generative extraction model comprises a generative pre-trained transformer.

9. The computer-implemented method of claim 1, further comprising:
initiating a prediction-based action based on the target classification signature by identifying a plurality of entities that correspond to the target classification based on a comparison between the target classification signature and a plurality of text-based objects respectively corresponding to the plurality of entities.

10. The computer-implemented method of claim 1, wherein generating the target classification signature comprises:
extracting one or more of the sequence of words from each of the one or more explanatory summary segments; and
concatenating the sequence of words to form the target classification signature.

11. A system comprising memory and one or more processors communicatively coupled to the memory, the one or more processors configured to:
generate, using a trained classifier model, a plurality of target classification probabilities for a plurality of labelled text-based objects from a testing portion of a labelled training dataset;
identify at a first stage, one or more predictive text-based objects from the plurality of labelled text-based objects based on the plurality of target classification probabilities;
identify at a second stage, via staged prompting to a generative extraction model, a target set of explanatory text segments from the one or more predictive text-based objects;
generate one or more semantic segment clusters from the target set of explanatory text segments;
generate, using a generative summarization model, one or more explanatory summary segments respectively corresponding to the one or more semantic segment clusters;
extract at a third stage, a sequence of words from the one or more explanatory summary segments to generate a target classification signature; and
store the target classification signature in association with a target classification.

12. The system of claim 11, wherein the trained classifier model is previously trained, using one or more supervisory training techniques, based on a training portion of the labelled training dataset.

13. The system of claim 11, wherein the one or more predictive text-based objects are associated with a top ten percentile of the plurality of target classification probabilities.

14. The system of claim 11, wherein generating the one or more semantic segment clusters from the target set of explanatory text segments comprises:
generating, using an encoder model, an explanatory embedding based on the target set of explanatory text segments; and
generating the one or more semantic segment clusters based on the explanatory embedding.

15. The system of claim 14, wherein generating the explanatory embedding comprises:
generating a target text document by concatenating the target set of explanatory text segments from the one or more predictive text-based objects; and
transforming, using the encoder model, the target text document into the explanatory embedding.

16. The system of claim 14, wherein a number of the one or more semantic segment clusters is based on a configurable clustering parameter and generating the one or more semantic segment clusters comprises:
generating, using a k-nearest neighbor clustering algorithm, the one or more semantic segment clusters based on the configurable clustering parameter.

17. The system of claim 11, wherein the staged prompting comprises:
inputting, to the generative extraction model, a naïve prompt for the target classification to identify a naïve set of explanatory text segments from the one or more predictive text-based objects;
generating a target classification prompt based on the naïve set of explanatory text segments; and
inputting, to the generative extraction model, the target classification prompt to identify the target set of explanatory text segments from the naïve set of explanatory text segments.

18. One or more non-transitory computer-readable storage media including instructions that, when executed by one or more processors, cause the one or more processors to:
generate, using a trained classifier model, a plurality of target classification probabilities for a plurality of labelled text-based objects from a testing portion of a labelled training dataset;
identify at a first stage, one or more predictive text-based objects from the plurality of labelled text-based objects based on the plurality of target classification probabilities;
identify at a second stage, via staged prompting to a generative extraction model, a target set of explanatory text segments from the one or more predictive text-based objects;
generate one or more semantic segment clusters from the target set of explanatory text segments;
generate, using a generative summarization model, one or more explanatory summary segments respectively corresponding to the one or more semantic segment clusters;
extract at a third stage, a sequence of words from the one or more explanatory summary segments to generate a target classification signature; and
store the target classification signature in association with a target classification.

19. The one or more non-transitory computer-readable storage media of claim 18, wherein the trained classifier model is previously trained, using one or more supervisory training techniques, based on a training portion of the labelled training dataset.

20. The one or more non-transitory computer-readable storage media of claim 18, wherein the one or more processors are further caused to:
initiate a prediction-based action based on the target classification signature by identifying a plurality of entities that correspond to the target classification based on a comparison between the target classification signature a plurality of text-based objects respectively corresponding to the plurality of entities.
